(19) United States
(12) Patent Application Publication
(10) Pub. No.: US 2005/0234626 A1
(43) Pub. Date: Oct. 20, 2005

(54) Deceleration control apparatus and deceleration control method for vehicle

(75) Inventors: Kazuyuki Shiiba, Susono-shi (JP); Kunihiro Iwatsuki, Toyota-shi (JP); Shinya Iizuka, Susono-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/085,177

(22) Filed: Mar. 22, 2005

(30) Foreign Application Priority Data
Apr. 14, 2004 (JP) 2004-119238

(51) Int. Cl. G06F 17/00

(52) U.S. Cl. 701/70; 701/72; 701/80

(57) ABSTRACT

A target deceleration for running on a curved road ahead of a vehicle is obtained, based on a driver's intention which is input or estimated, and a driver's driving skill level which is input or estimated; and deceleration control is performed so that deceleration applied to the vehicle becomes equal to the target deceleration. In a case where the driver's intention is to cause the vehicle to respond to driving operation relatively quickly, the target deceleration may be set to a relatively small value; and in a case where the driving skill level is relatively high, the target deceleration is set to a relatively small value. Further, the target deceleration is decided based on a state of a road where the vehicle runs.

### INCORPORATION BY REFERENCE

The disclosure of Japanese Patent Application No. 2004-119238 filed on Apr. 14, 2004 including the specification, drawings and abstract is incorporated herein by reference in its entirety.

### BACKGROUND OF THE INVENTION

1. Field of the Invention

The invention relates to a deceleration control apparatus and deceleration control method for a vehicle. More particularly, the invention relates to a deceleration control apparatus and deceleration control method for a vehicle, which performs deceleration control that allows a driver to feel comfortable.

2. Description of the Related Art

Japanese Patent Application Publication No. JP-A-2003-99897 discloses a technology in which only a warning is given during cornering in a case where a highly skilled driver drives a vehicle, and a warning is given and deceleration control is performed during cornering in a case where a less skilled driver drives a vehicle, that is, a technology in which support is changed according to the driving skill level of a driver. In the technology, support timing is changed according to the driving skill level of the driver. For example, support is provided earlier in a case where a less skilled driver drives a vehicle. Also, in the technology, the driving skill level of the driver is determined by comparing a variance or an average value of a vehicle speed, an amount of change in a steering angle, and an amount of change in braking operation to database relating to an ordinary driving skill level.

Japanese Patent Application Publication No. JP-A-11-222055 discloses a technology in which when a corner is detected ahead of a host vehicle, and a driver's intention to perform deceleration is detected, deceleration control is performed. In the technology, a deceleration control amount is calculated based on a vehicle speed at a corner (hereinafter, referred to as “cornering vehicle speed”), a vehicle speed at a spot where the driver's intention to perform deceleration is detected, and a distance between the spot where the driver's intention to perform deceleration is detected to a spot where cornering is started. Also, in the technology, the cornering vehicle speed is detected based on a radius of a corner, and is corrected based on a characteristic of a driver's operation, weather, a road inclination, road surface μ, and frequency with which a vehicle runs at the corner.

In the technology disclosed in the Japanese Patent Application Publication No. JP-A-2003-99897, since the amount of change in the steering angle and the amount of change in the braking operation are likely to increase during sport running, it may be determined that the driver's driving skill level is low. As a result, an unnecessary warning may be given, and unnecessary control may be performed. Also, in the technology disclosed in the Japanese Patent Application Publication No. JP-A-2003-99897, support is given to the driver when it is determined that a situation is dangerous. Therefore, it cannot be expected that driveability is improved, and a load on the driver is reduced.

In the technology disclosed in the Japanese Patent Application Publication No. JP-A-11-222055, the characteristic of the driver's operation is determined based on frequency with which an accelerator pedal, a brake pedal, and the like are operated. When the number of times that the accelerator pedal, the brake pedal, and the like are operated is large, it is determined that a driver is unfamiliar with a road. When it is determined that the driver is unfamiliar with the road, the cornering vehicle speed is corrected so as to be decreased. In the technology disclosed in the aforementioned Japanese Patent Application Publication No. JP-A-11-222055, when the driver performs sport running, the frequency with which the accelerator pedal and the brake pedal are operated is increased, and therefore it is likely to be determined that the driver is unfamiliar with the road. In general, the cornering vehicle speed is high when sport running is performed. However, the vehicle speed is corrected so as to be decreased for the reason described above. Thus, the deceleration control is performed against the driver's intention.

### SUMMARY OF THE INVENTION

It is an object of the invention to provide a deceleration control apparatus and deceleration control method for a vehicle, which makes it possible to apply desired deceleration to a vehicle so that a driver feels comfortable.

A first aspect of the invention relates to a deceleration control apparatus for a vehicle. The deceleration control apparatus for a vehicle includes a calculation device which calculates a target deceleration for running on a curved road ahead of a vehicle, based on driver's intention relating to running of the vehicle which is input or estimated, and a driver's driving skill level which is input or estimated; and a control device which performs deceleration control for the vehicle based on the calculated target deceleration.

In the first aspect of the invention, the desired deceleration can be applied to the vehicle so that the driver feels comfortable.

In the first aspect of the invention, in a case where the driver's intention is to cause the vehicle to respond to driving operation relatively quickly, the calculation device may set the target deceleration to a relatively small value; and in a case where the driving skill level is relatively high, the calculation device may set the target deceleration to a relatively small value.

In the first aspect and an aspect relating to the first aspect, the calculation device may set the target deceleration based on a state of a road where the vehicle runs.

In the first aspect, the deceleration control apparatus may further include a driving skill estimating portion that estimates the driving skill level based on at least one of data that is input by the driver, a result of statistical analysis of an operation amount relating to driving, and a difference between ideal operation and actual operation.

In the first aspect, the deceleration control apparatus may further include a driver's intention estimating portion that estimates the driver's intention relating to running of the vehicle, based on at least one of a driving state of the driver and a running state of the vehicle.

In the first aspect, the driver's intention estimating portion may include a neural network which receives at least one of plural variables related to driving operation, and starts an estimating operation every time the at least one variable is calculated; and the driver's intention estimating portion may estimate the driver's intention in the vehicle based on output from the neural network.

In the first aspect, the control device may perform the deceleration control so that a deceleration applied to the vehicle becomes equal to the target deceleration using cooperative control of a brake and an automatic transmission.

In the first aspect, the calculation device may correct the target deceleration according to an inclination of a road where the vehicle runs.

In the first aspect, the calculation device may correct the target deceleration such that a maximum lateral acceleration becomes smaller as a friction coefficient of a road becomes smaller.

A second aspect of the invention relates to a deceleration control method for a vehicle. The deceleration control method includes calculating a target deceleration for running on a curved road ahead of a vehicle, based on driver's intention relating to running of the vehicle which is input or estimated, and a driver's driving skill level which is input or estimated; and performing deceleration control for the vehicle based on the calculated target deceleration.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a flowchart showing operation of a deceleration control apparatus for a vehicle according to a first embodiment of the invention;

FIG. 2 is a schematic diagram showing a configuration of the deceleration control apparatus for a vehicle according to the first embodiment of the invention;

FIG. 3 is a skeleton diagram explaining an automatic transmission of the deceleration control apparatus for a vehicle according to the first embodiment of the invention;

FIG. 4 is a diagram showing an operation table for the automatic transmission shown in FIG. 3;

FIG. 5A is a graph showing the maximum lateral acceleration during cornering when sport running is performed;

FIG. 5B is a graph showing the maximum lateral acceleration during cornering when normal running is performed;

FIG. 6 is a diagram explaining a vehicle speed and a deceleration before entering a corner in the deceleration control apparatus for a vehicle according to the first embodiment of the invention;

FIG. 7 is another diagram explaining the vehicle speed and the deceleration before entering a corner in the deceleration control apparatus for a vehicle according to the first embodiment of the invention;

FIG. 8 is a diagram showing a body moving on a circle;

FIG. 9 is a map for obtaining the maximum lateral acceleration in the deceleration control apparatus for a vehicle according to the first embodiment of the invention;

FIG. 10 is a map for correcting the maximum lateral acceleration in the deceleration control apparatus according to the first embodiment of the invention;

FIG. 11 is a diagram showing a configuration for estimating driver's intention in the deceleration control apparatus for a vehicle according to the first embodiment of the invention;

FIG. 12 is a map for obtaining deceleration according to each vehicle speed and each shift speed in a deceleration control apparatus for a vehicle according to a second embodiment of the invention;

FIG. 13 is a diagram explaining a shift speed target deceleration in the deceleration control apparatus for a vehicle according to the second embodiment of the invention;

FIG. 14 is a diagram showing a shift speed corresponding to a vehicle speed and deceleration in the deceleration control apparatus for a vehicle according to the second embodiment of the invention; and

FIG. 15 is a map for determining a coefficient corresponding to road surface μ in a deceleration control apparatus for a vehicle according to a third embodiment of the invention.

### DETAILED DESCRIPTION OF THE PREFERRED EMBODIMENTS

Hereinafter, a deceleration control apparatus for a vehicle according to each of exemplary embodiments of the invention will be described in detail with reference to the drawings.

### First Embodiment

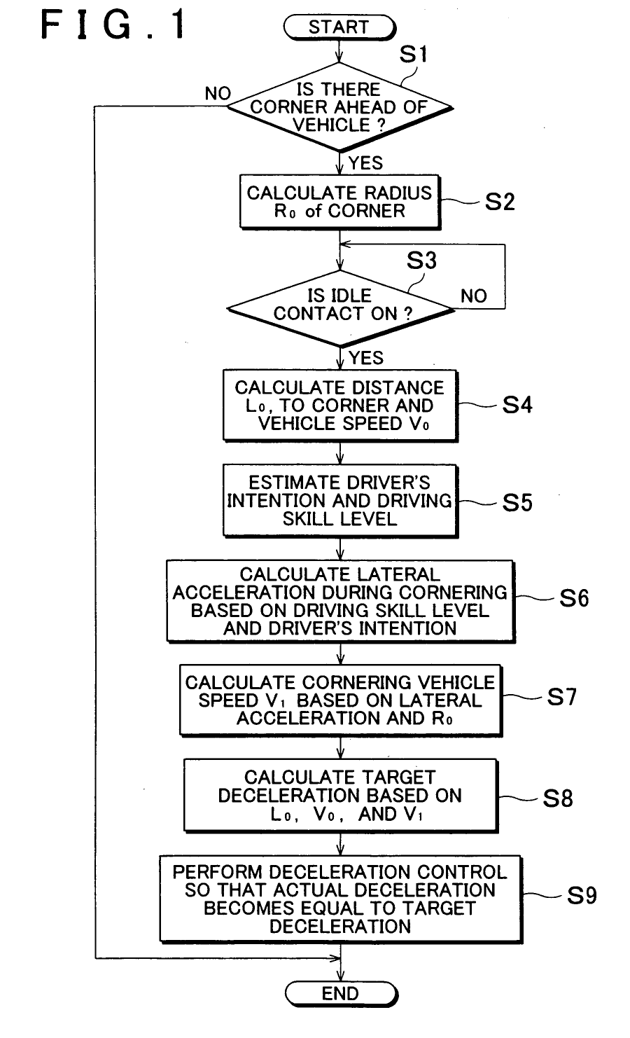

A first embodiment will be described with reference to FIG. 1 to FIG. 11. The first embodiment relates to a deceleration control apparatus for a vehicle, which performs deceleration control using a brake (braking device).

In this embodiment, in deceleration control which decreases a vehicle speed to an appropriate cornering vehicle speed when a corner is detected ahead of a vehicle, and driver's intention to perform deceleration is detected, a target gravitational deceleration (hereinafter, referred to as “target deceleration”) is calculated based on driver's intention relating to running of the vehicle, a driving skill level, a vehicle speed when an accelerator pedal is released, a distance to the corner, and a radius of the corner. The deceleration control is performed so that actual deceleration becomes equal to the target deceleration. Thus, the deceleration control which allows the driver to feel comfortable is performed.

As described later in detail, a deceleration control apparatus for a vehicle according to the embodiment of the invention includes means for calculating a radius of a corner ahead of a host vehicle, and a distance from a present position to an entry of the corner using a navigation system and the like; means for estimating a driver's driving skill level and the driver's intention relating to running of the vehicle (e.g., the driver's intention to perform sport running, normal running, and slow running); means for detecting the driver's intention to perform deceleration based on accelerator operation, brake operation, and the like; and deceleration means which can control the deceleration of the host vehicle, such as a brake actuator and an automatic transmission (AT) including a continuously variable transmission (CVT), a transmission for a hybrid vehicle (HV), and a manual mode transmission (MMT).

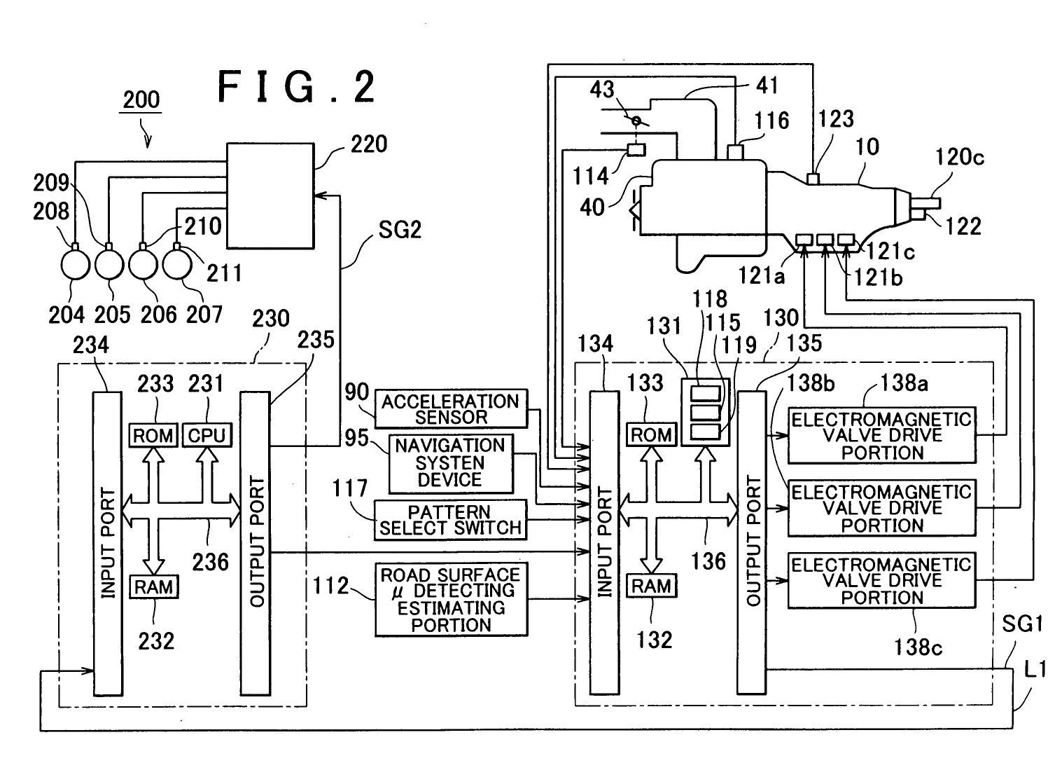

In FIG. 2, the vehicle including the deceleration control apparatus is provided with a stepped automatic transmission 10, an engine 40, and a brake device 200. In the automatic transmission 10, hydraulic pressure is controlled by energizing/deenergizing electromagnetic valves 121a, 121b, and 121c, whereby five shift speeds can be achieved. In FIG. 2, the three electromagnetic valves 121a, 121b, and 121c are shown. However, the number of the electromagnetic valves is not limited to three. The electromagnetic valves 121a, 121b, and 121c are driven according to a signal supplied from a control circuit 130.

A throttle opening degree sensor 114 detects an opening degree of a throttle valve 43 provided in an intake passage 41 for the engine 40. An engine rotational speed sensor 116 detects a rotational speed of the engine 40. A vehicle speed sensor 122 detects a rotational speed of an output shaft 120c of the automatic transmission 10 which is proportional to the vehicle speed. A shift position sensor 123 detects a shift position. A pattern select switch 117 is used for indicating a shift pattern. An acceleration sensor 90 detects deceleration (acceleration) of the vehicle. A road surface μ detecting estimating portion 112 detects or estimates a friction coefficient μ of a road, or a slip degree of a road.

A navigation system device 95 has a basic function of guiding the host vehicle to a predetermined destination. The navigation system device 95 includes a processor; an information storage medium which stores information necessary for running of the vehicle (a map, straight roads, curved roads, ascending and descending slopes, highways, and the like); a first information detecting device which detects a present position of the host vehicle, a road situation, and the like using self navigation, and which includes a geomagnetic sensor, a gyro compass, and a steering sensor; and a second information detecting device which detects the present position of the host vehicle, the road situation, and the like using radio navigation, and which includes a GPS antenna, a GPS receiver, and the like.

The control circuit 130 receives a signal indicative of a detection result from each of the throttle opening degree sensor 114, the engine rotational speed sensor 116, the vehicle speed sensor 122, the shift position sensor 123, and the acceleration sensor 90. Also, the control circuit 130 receives a signal indicative of a switching state of the pattern select switch 117, a signal indicative of the navigation system device 95, and a signal indicative of detection or estimation performed by the road surface μ detecting estimating portion 112.

The control circuit 130 is constituted by a known microcomputer. The control circuit 130 includes a CPU 131, RAM 132, ROM 133, an input port 134, an output port 135, and a common bus 136. The input port 134 receives signals from the aforementioned sensors 114, 116, 122, 123, and 90, a signal from the aforementioned switch 117, and a signal from the navigation system device 95. The output port 135 is connected to electromagnetic valve drive portions 138a, 138b, and 138c, and a braking force signal line L1 leading to a brake control circuit 230. A braking force signal SG1 is transmitted through the braking force signal line L1.

A road inclination measuring estimating portion 118 may be provided as a portion of the CPU 131. The road inclination measuring estimating portion 118 may measure or estimate a road inclination based on the deceleration (acceleration) detected by the acceleration sensor 90. Also, the road inclination measuring estimating portion 118 may cause the ROM 133 to store acceleration on a flat road in advance, and may obtain the road inclination by comparing the acceleration on the flat road and deceleration (acceleration) that is actually detected by the acceleration sensor 90.

A driver's intention estimating portion 115 may be provided as a portion of the CPU 131. The driver's intention estimating portion 115 estimates the driver's intention relating to running of the vehicle (the driver's intention to perform sport running or the driver's intention to perform normal running), based on a driving state of the driver and a running state of the vehicle. The driver's intention estimating portion 115 will be described in more detail later. The configuration of the driver's intention estimating portion 115 is not limited to the configuration described later. The driver's intention estimating portion 115 may have various configurations as long as the driver's intention estimating portion 115 estimates the driver's intention. The term “driver's intention to perform sport running” signifies that the driver intends to place emphasis on engine performance, or to perform acceleration, or the driver intends to cause the vehicle to respond to the driver's operation quickly, that is, the driver wants to perform sport running.

A driving skill level estimating portion 119 may be provided as a portion of the CPU 131. The driving skill level estimating portion 119 estimates the driver's driving skill level based on information relating to the driver that is input to the driving skill level estimating portion 119. In this embodiment, the configuration of the driving skill level estimating portion 119 is not limited to a specific configuration as long as the driving skill level estimating portion 119 estimates the driver's driving skill level. Also, the meaning of the driving skill level estimated by the driving skill level estimating portion 119 is broadly interpreted.

The driving skill level estimating portion 119 may be included in one of the following three categories (1) to (3). However, as described above, the configuration of the driving skill level estimating portion 119 is not limited to the configurations in (1) to (3) described below.

(1) A device which estimates a driving skill level based on data which is input by a driver or the like.

(2) A device which estimates a driving skill level by performing statistic analysis of a driving operation amount.

(3) A device which estimates a driving skill level based on a difference between ideal operation and actual operation.

Examples of the configuration of the driving skill level estimating portion 119 in the category (1) include the following three technologies.

A technology in which a driving skill level is estimated based on date on which a driver's license is obtained (for example, a technology disclosed in Japanese Patent Application Publication No. JP-A-10-185603).

A technology in which a driving skill level is estimated based on answers to questions that have been prepared in advance (for example, a technology disclosed in Japanese Patent Application Publication No. JP-A-10-300496).

A technology in which a driving skill level is estimated by a bystander who rides on the vehicle together with a driver (for example, a technology disclosed in Japanese Patent Application Publication No. JP-A-6-328986).

Examples of the configuration of the driving skill level estimating portion 119 in the category (2) include the following eight technologies.

A technology in which a driving skill level is determined based on a slip amount of a clutch in a vehicle with a manual transmission, and it is estimated that a driver's driving skill level is high when the slip amount is small (a technology disclosed in Japanese Patent Application Publication No. JP-A-2003-81040).

A technology relating to a vehicle speed while a vehicle moves backward, in which it is determined that a driver's driving skill level is high when a vehicle speed is high while the vehicle moves backward (a technology disclosed in the Japanese Patent Application Publication No. JP-A-2003-81040).

A technology relating to skill in parking, in which it is estimated that a driver's driving skill level is high when the number of times that a moving direction is changed between a forward direction and a backward direction, and the number of times that a driver cuts a steering wheel are small (a technology disclosed in the Japanese Patent Application Publication No. JP-A-81040).

A technology in which a driving skill level is estimated based on the number of times that brake is applied suddenly and an average vehicle speed (a technology disclosed in Japanese Patent Application Publication No. JP-A-2001-354047).

A technology in which a driving skill level is estimated based on frequency with which a driver ignores a traffic light, a vehicle speed of a host vehicle, and frequency with which brake is applied suddenly or a steering wheel is turned suddenly (a technology disclosed in Japanese Patent Application Publication No. JP-A-6-162396).

A technology in which a yaw rate is recorded at unit time intervals, the recorded yaw rates are smoothly connected to obtain data using least squares method, and a driver's skill level is estimated based on an integral value of a difference between the obtained data and actual data (a technology disclosed in Japanese Patent Application Publication No. JP-A-10-198896).

A technology in which a driving skill level is estimated based on a coefficient of correlation between a front/rear wheel speed difference and a counter steering angle during counter steering operation, a coefficient of correlation between a yaw rate and the maximum steering angle while a vehicle turns, and a coefficient of correlation between a vehicle speed and the maximum steering angle when the vehicle slips (a technology disclosed in Japanese Patent Application Publication No. JP-A-8-150914).

A technology in which a driving skill level is estimated based on a variance of a cornering vehicle speed, an average of an amount of displacement from a target trajectory, and a time-series change in brake and a steering angle (a differential value) (a technology disclosed in Japanese Patent Application Publication No. JP-A-2003-99897).

Examples of the configuration of the driving skill level estimating portion 119 in the category (3) include the following four technologies.

A technology in which a trajectory during cornering is calculated based on a steering angle and a vehicle speed, the trajectory is compared to a trajectory made by a highly skilled driver, and a driving skill level is estimated based on a difference therebetween (a technology disclosed in Japanese Patent Application Publication No. JP-A-6-15199).

A technology in which an optimal steering angle is calculated based on a slip rate between a tire and a road and map information, and a driving skill level is estimated based on an average value of a difference between the optimal steering angle and an actual steering angle. In the technology, since a driver generally tries to recover a vehicle's balance by performing counter steering operation when a grip of a tire is lost during cornering, a driving skill level is estimated based on a length of a reaction time until the counter steering operation is performed (a technology disclosed in Japanese Patent Application Publication No. JP-A-7-306998).

A technology in which a target running trajectory during cornering is estimated using map information and a camera, and a driving skill level is estimated based on a length of a time period during which an actual running trajectory is deviated from this target running trajectory (a technology disclosed in Japanese Patent Application Publication No. JP-A-9-132060).

A technology in which a value of difference between an estimated steering angle and an actual steering angle in a case where steering is smoothly performed is obtained, and a driving skill level is estimated based on a degree of dispersion in the values of difference (a technology disclosed in Japanese Patent Application Publication No. JP-A-11-227491).

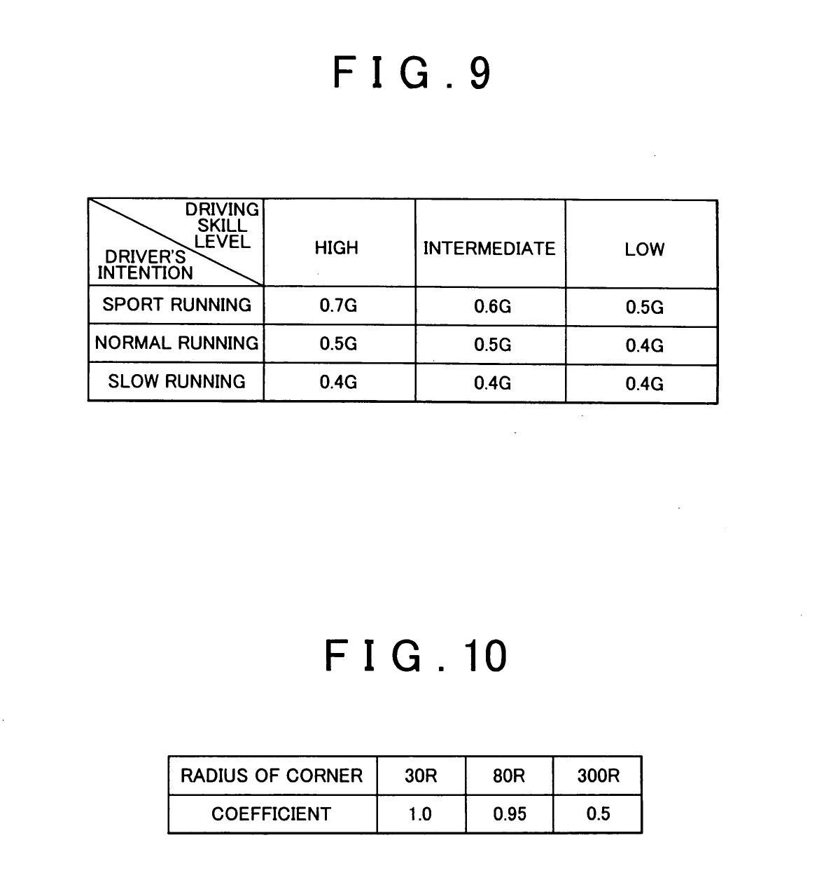

Operations (control steps) shown in a flowchart in FIG. 1, and maps shown in FIG. 9 and FIG. 10 are stored in the ROM 133 in advance. Also, operations in shift control (not shown) are stored in the ROM 133. The control circuit 130 performs shifting of the automatic transmission 10 based on various control conditions that are input thereto.

The brake device 200 is controlled by the brake control circuit 230 which receives the braking force signal SG1 from the control circuit 130 so as to apply brake to the vehicle. The brake device 200 includes a hydraulic pressure control circuit 220, and braking devices 208, 209, 210, and 211 which are provided in wheels 204, 205, 206, and 207, respectively. Braking hydraulic pressure of each of the braking devices 208, 209, 210, and 211 is controlled by the hydraulic pressure control circuit 220, whereby braking force of each of the corresponding wheels 204, 205, 206, and 207 is controlled. The hydraulic pressure control circuit 220 is controlled by the brake control circuit 230.

The hydraulic pressure control circuit 220 controls the braking hydraulic pressure to be supplied to each of the braking devices 208, 209, 210, and 211 based on a brake control signal SG2, thereby performing brake control. The brake control signal SG2 is generated by the brake control circuit 230 based on the braking force signal SG1. The braking force signal SG1 is output from the control circuit 130 of the automatic transmission 10, and is input to the brake control circuit 230. The braking force which is applied to the vehicle during the brake control is set by the brake control signal SG2 which is generated by the brake control circuit 230 based on various data included in the braking force signal SG1.

The brake control circuit 230 is constituted by a known microcomputer. The brake control circuit 230 includes a CPU 231, RAM 232, ROM 233, an input port 234, an output port 235, and a common bus 236. The output port 235 is connected to the hydraulic pressure control circuit 220. The ROM 233 stores operations performed when the brake control signal SG2 is generated based on various data included in the braking force signal SG1. The brake control circuit 230 performs control of the brake device 200 (brake control) based on various control conditions that are input thereto.

Next, the driver's intention estimating portion 115 will be described in detail.

The driver's intention estimating portion 115 includes a neural network NN which receives at least one of plural variables related to driving operation (hereinafter, referred to as “driving operation-related variables”), and starts an estimating operation every time the at least one driving operation-related variable is calculated. The driver's intention estimating portion 115 estimates the driver's intention in the vehicle based on output from the neural network NN.

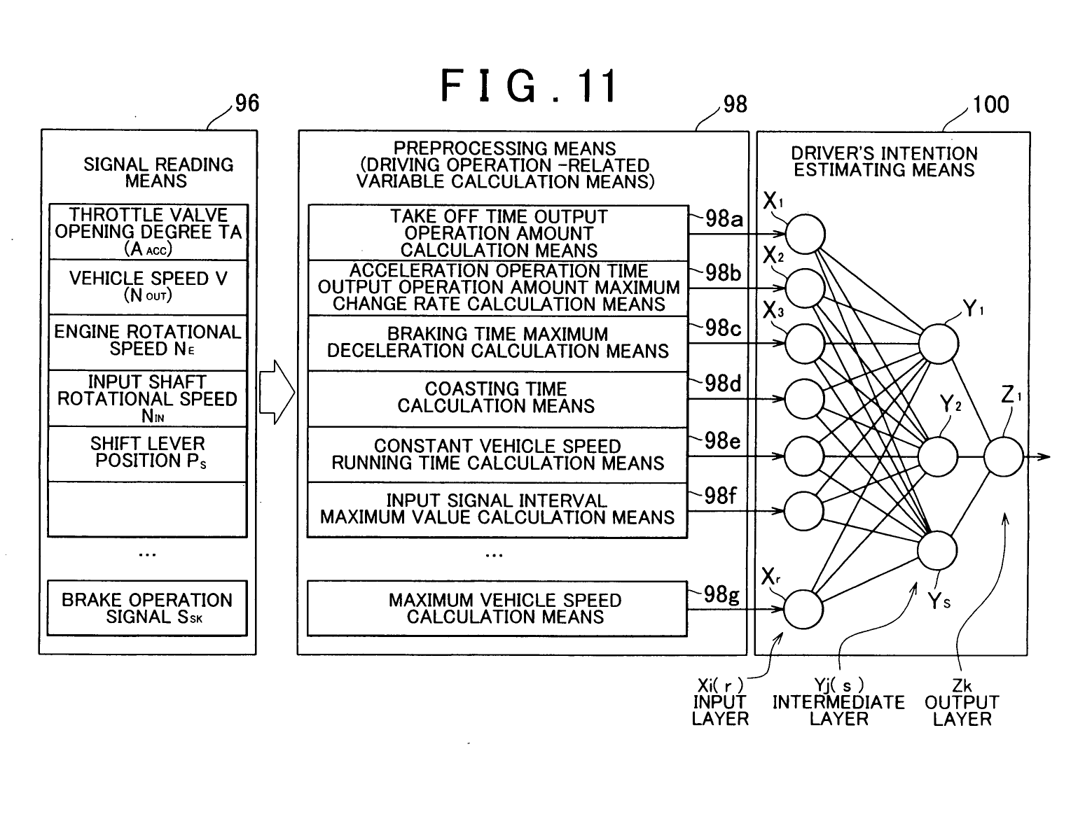

For example, as shown in FIG. 11, the driver's intention estimating portion 115 includes signal reading means 96, preprocessing means 98, and driver's intention estimating means 100. The signal reading means 96 reads detection signals from each of the aforementioned sensors 114, 122, 116, 124, and 225 in predetermined relatively short time intervals.

The preprocessing means 98 is driving operation-related variable calculation means for calculating each of the plural driving operation-related variables which are closely related to driving operation that reflects the driver's intention, based on signals sequentially read by the signal reading means 96. The plural driving operation-related variables include an output operation amount (an accelerator pedal operation amount) when the vehicle takes off, that is, a throttle valve opening degree TA_{ST} when the vehicle takes off; the maximum rate of change in the output operation amount when acceleration operation is performed, that is, the maximum rate Acc_{MAX} of change in the throttle valve opening degree when acceleration operation is performed; the maximum gravitational deceleration G_{NMAX} (hereinafter, referred to as “maximum deceleration”) when braking operation is performed in the vehicle; a vehicle costing time T_{COAST}; a vehicle constant running time T_{VCONST}; the maximum value of a signal input from each sensor in a predetermined interval; and the maximum vehicle speed Vₘₐₓ after driving operation is started.

The driver's intention estimating means 100 includes the neutral network NN which receives at least one of the plural driving operation-related variables, and starts the estimating operation for estimating the driver's intention every time the at least one driving operation-related variable is calculated by the preprocessing means 98. The driver's intention estimating means 100 outputs a driver's intention estimation value which is output from the neural network NN.

The preprocessing means 98 in FIG. 11 includes take off time output operation amount calculation means 98a, acceleration operation time output operation amount maximum change rate calculation means 98b, braking time maximum deceleration calculation means 98c, coasting time calculation means 98d, constant vehicle speed running time calculation means 98e, input signal interval maximum value calculation means 98f, and maximum vehicle speed calculation means 98g. The take off time output operation amount calculation means 98a calculates the output operation amount when the vehicle takes off, that is, the throttle valve opening degree TA_{ST} when the vehicle takes off. The acceleration operation time output operation amount maximum change rate calculation means 98b calculates the maximum rate of change in the output operation amount when acceleration operation is performed, that is, the maximum rate of change Acc_{MAX} of the throttle valve opening degree. The braking time maximum deceleration calculation means 98c calculates the maximum deceleration G_{NMAX} when braking operation is performed in the vehicle. The coasting time calculation means 98d calculates the vehicle costing time T_{COAST}. The constant vehicle speed running time calculation means 98e calculates the constant vehicle speed running time T_{VCONST}. The input signal interval maximum value calculation means 98f periodically calculates the maximum value of the signal input from each sensor in the predetermined interval of, for example, approximately three seconds. The maximum vehicle speed calculation means 98g calculates the maximum vehicle speed V_{MAX} after driving operation is started.

As the maximum value of the input signal in the predetermined interval which is calculated by the input signal interval maximum value calculation means 98f, it is possible to employ a throttle valve opening degree TAₘₐₓₜ, a vehicle speed Vₘₐₓₜ, an engine rotational speed N_{Emaxt}, longitudinal acceleration NOGBWₘₐₓₜ (which is a negative value when the vehicle speed is decreased) or deceleration G_{NMAXt} (absolute value). The longitudinal acceleration NOGBWₘₐₓₜ or deceleration G_{NMAXt} is obtained, for example, based on a rate of change in the vehicle speed V (N_{OUT}).

The neural network NN included in the driver's intention estimating means 100 shown in FIG. 11 is configured by modeling a group of neurons of the driver. Also, the neural network NN is configured using software of a computer program, or hardware formed by connecting electronic elements. For example, the neural network NN is configured as shown in a block representing the driver's intention estimating means 100 in FIG. 11.

In FIG. 11, the neural network NN is a hierarchical network having a three-layer structure. The neural network NN includes an input layer, an intermediate layer, and an output layer. The input layer is composed of neural elements Xᵢ (X₁ to Xᵣ) the number of which is “r”. The intermediate layer is composed of neural elements Yⱼ (Y₁ to Yₛ) the number of which is “s”. The output layer is composed of neural elements Zₖ, (Z₁ to Zₜ) the number of which is “t”. In order to transmit a state of the neural elements from the input layer to the output layer, a transmission element D_{Xij}, and a transmission element D_{Yjk}. The transmission element D_{Xij} has a connection coefficient (weight) W_{Xij}, and connects the neural elements Xᵢ the number of which is “r”, to the neural elements Yⱼ the number of which is “s”. The transmission element D_{Yjk} has a connection coefficient (weight) W_{Yjk}, and connects the neural elements Yⱼ the number of which is “s”, to the neural elements Zₖ the number of which is “t”.

The neural network NN is a pattern association system in which the connection coefficient (weight) W_{Xij}, and the connection coefficient (weight) W_{Yjk} are learned using a so-called error back propagation learning algorithm. The learning is completed in advance through driving experiment for relating values of the driving operation-related variables to the driver's intention. Therefore, when the vehicle is assembled, each of the connection coefficient (weight) W_{Xij}, and the connection coefficient (weight) W_{Yjk} is set to a fixed value.

When the learning is performed, each of plural drivers drives a vehicle according to the intention to perform sport running, and according to the intention to perform normal running, on various roads such as a highway, a road in a suburb, a mountain road, and a road in a city. While driving the vehicle, the driver's intention is represented by a teacher signal. The teacher signal and indicators the number of which is “n” are input to the network NN. The indicators are obtained by preprocessing sensor signals. That is, the teacher signal and the input signal are input to the network NN. The teacher signal represents the driver's intention using a value in a range of 0 to 1. For example, the driver's intention to perform normal running is represented by “0”, and the driver's intention to perform sport running is represented by “1”. Also, the input signal is normalized to a value in a range of −1 to +1, or a value in a range of 0 to 1.

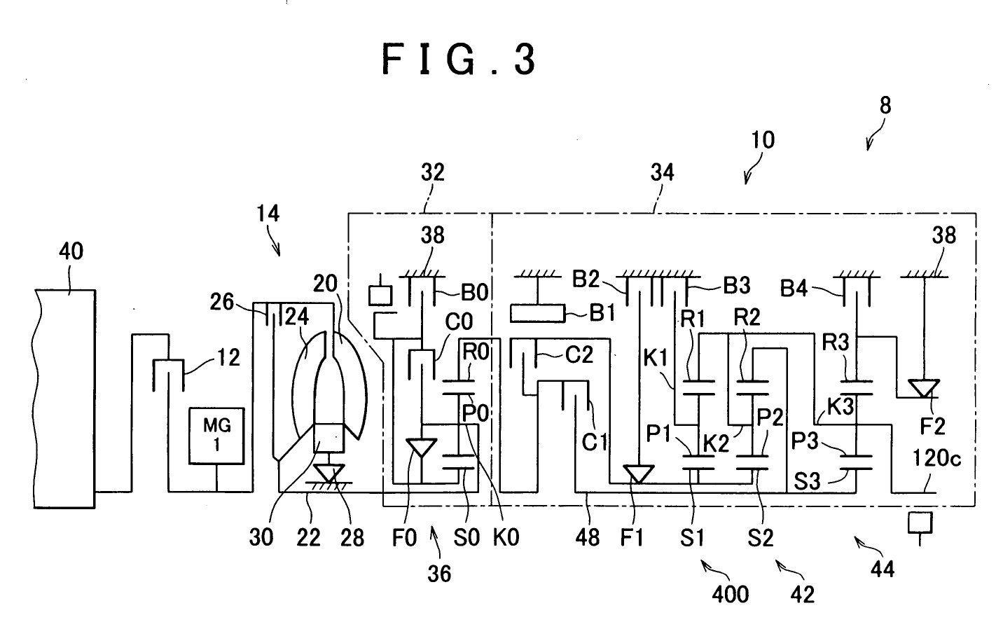

Next, FIG. 3 shows a configuration of the automatic transmission 10. In FIG. 3, the engine 40 is a driving source for running, and is constituted by an internal combustion engine. Output from the engine 40 is input to the automatic transmission 10 through an input clutch 12, and a torque converter 14 which is a hydraulic power transmission device, and then is transmitted to a drive shaft through a differential gear unit (not shown) and an axle. A first motor/generator MG1 which functions as a motor and a generator is provided between the input clutch 12 and the torque converter 14.

The torque converter 14 includes a pump impeller 20 connected to the input clutch 12; a turbine runner 24 connected to an input shaft 22 of the automatic transmission 10; a lock up clutch 26 which directly connects the pump impeller 20 to the turbine impeller 24; and a stator impeller 30 whose rotation in one way is inhibited by a one way clutch 28.

The automatic transmission 10 includes a first shifting portion 32 which performs switching between two shift speeds, that are, a high shift speed and a low shift speed; and a second shifting portion 34 which can perform switching among a reverse shift speed and four forward shift speeds. The first shifting portion 32 includes an HL planetary gear unit 36, a clutch C0, a one way clutch F0, and a brake B0. The HL planetary gear unit 36 includes a sun gear S0, a ring gear R0, and a planetary gear P0 which is rotatably supported by a carrier K0, and which is engaged with the sun gear S0 and the ring gear R0. The clutch C0 and the one way clutch F0 are provided between the sun gear S0 and the carrier K0. The brake B0 is provided between the sun gear S0 and a housing 38.

The second shifting portion 34 includes a first planetary gear unit 400, a second planetary gear unit 42, and a third planetary gear unit 44. The first planetary gear unit 400 includes a sun gear S1, a ring gear R1, and a planetary gear P1 which is rotatably supported by a carrier K1, and which is engaged with the sun gear S1 and the ring gear R1. The second planetary gear unit 42 includes a sun gear S2, a ring gear R2, and a planetary gear P2 which is rotatably supported by a carrier K2, and which is engaged with the sun gear S2 and the ring gear R2. The third planetary gear unit 44 includes a sun gear S3, a ring gear R3, and a planetary gear P3 which is rotatably supported by a carrier K3, and which is engaged with the sun gear S3 and the ring gear R3.

The sun gear S1 and the sun gear S2 are integrally connected to each other. The ring gear R1, the carrier K2, and the carrier K3 are integrally connected to each other. The carrier K3 is connected to an output shaft 120c. Also, the ring gear R2 is integrally connected to the sun gear S3 and an intermediate shaft 48. A clutch C1 is provided between the ring gear R0 and the intermediate shaft 48. A clutch C2 is provided between the sun gears S1, S2, and the ring gear R0. A band brake B1 which stops rotation of the sung gear S1 and rotation of the sun gear S2 is provided in the housing 38. Also, a one way clutch F1 and a brake B2 are provided in series between the sun gears S1, S2 and the housing 38. The one way clutch F1 is engaged when the sun gear S1 and the sun gear S2 tries to rotate in a reverse direction that is opposite to a direction in which the input shaft 22 rotates.

A brake B3 is provided between the carrier K1 and the housing 38. A brake B4 and a one way clutch F2 are provided in parallel between the ring gear R3 and the housing 38. The one way clutch F2 is engaged when the ring gear R3 tries to rotate in the reverse direction.

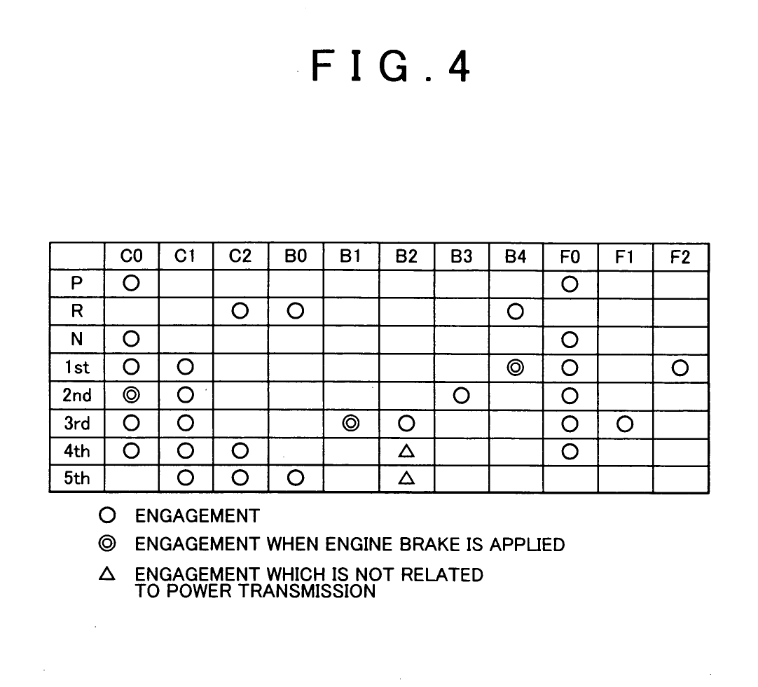

In the automatic transmission 10 that is thus configured, switching is performed among one reverse shift speed and five forward shift speeds (first speed to fifth speed), for example, according to an operation table shown in FIG. 4. A gear ratio sequentially varies from the first shift speed to the fifth shift speed. In FIG. 4, a circle indicates engagement, a blank indicates disengagement, a double circle indicates engagement when engine brake is applied, and a triangle indicates engagement which is not related to power transmission. Each of the clutches C0 to C2, and the brakes B0 to B4 is a hydraulic friction engagement device which is engaged by a hydraulic actuator.

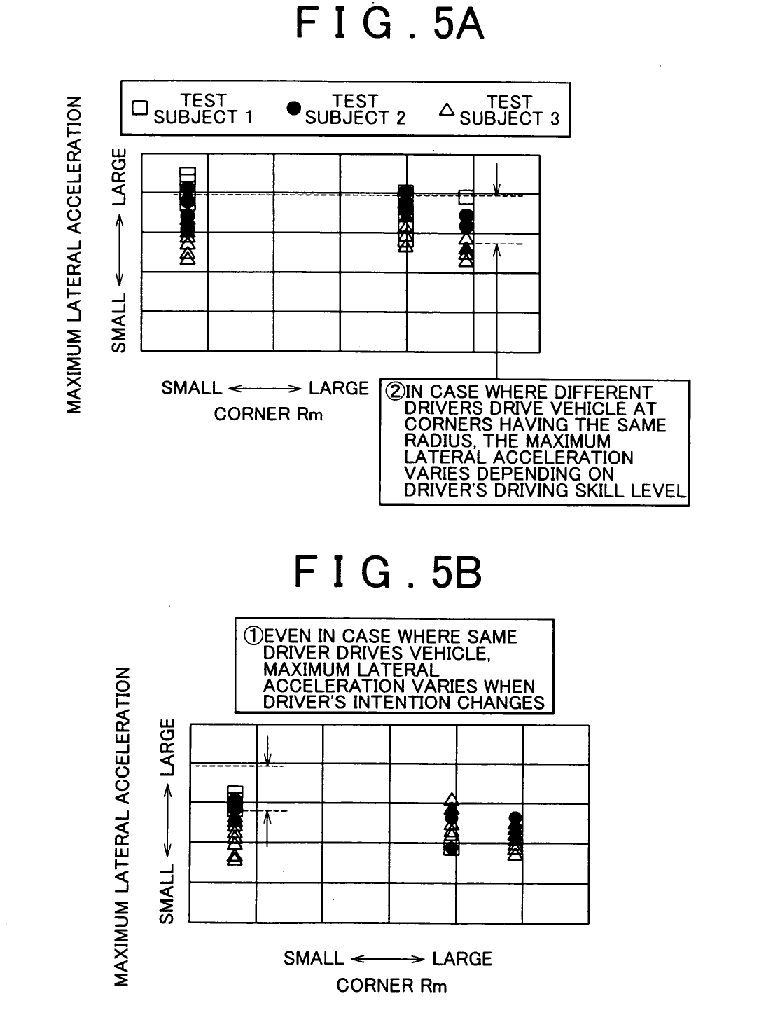

FIG. 5A shows the maximum lateral acceleration during cornering when sport running is performed (i.e., when the vehicle speed is relatively high). FIG. 5B shows the maximum lateral acceleration during cornering when the driver intends to perform normal running (i.e., when the vehicle speed is relatively low). Each of FIG. 5A and FIG. 5B shows a result of experiment performed on three test subjects whose driving skill levels are different from each other.

As shown in FIG. 5A and FIG. 5B, in a case where a driver drives a vehicle at a corner according to the intention to perform sport running, and the same driver drives the vehicle at a corner having the same radius according to the intention to perform normal running, the maximum lateral acceleration is great when the driver drives the vehicle according to the intention to perform sport running, as compared to when the driver drives the vehicle according to the intention to perform normal running. That is, even in the case where the same driver drives the vehicle, the maximum lateral acceleration varies when the driver's intention changes. For example, in a case where the maximum lateral acceleration is set so as to be suitable for normal running irrespective of the driver's intention, and deceleration control is performed, the deceleration becomes greater than expected by the driver, and the driver feels uncomfortable when the driver drives the vehicle according to the intention to perform sport running. Meanwhile, in a case where the maximum lateral acceleration is set so as to be suitable for sport running irrespective of the driver's intention, and deceleration control is performed, the deceleration becomes insufficient, and therefore the driver needs to pay attention not only to steering operation, but also to brake operation during normal running. Accordingly, the driver's comfort level is reduced.

Also, as shown in FIG. 5A and FIG. 5B, in a case where different drivers drive the vehicle at corners having the same radius according to the same intention, the maximum lateral acceleration varies depending on the driver's driving skill level. When a test subject 1 whose driving skill level is relatively high drives the vehicle at a corner, the maximum lateral acceleration is great, as compared to when a test subject 3 whose driving skill level is relatively low drives the vehicle at the corner having the same radius. When the deceleration is set based on a result in the case of the test subject 3, the test subject 1 feels that the vehicle speed is low. Meanwhile, when the deceleration is set based on a result in the case of the test subject 1, the test subject 3 feels that the vehicle speed is high and dangerous. Thus, it is not possible to reflect the driver's intention.

The results of the aforementioned experiment performed by the inventor of this invention show that the deceleration expected by the driver cannot be obtained if the maximum lateral acceleration is not calculated based on both of the driver's intention and the driver's driving skill level. Thus, it has been found that the maximum lateral acceleration should be calculated based on both of the driver's intention and the driver's driving skill level.

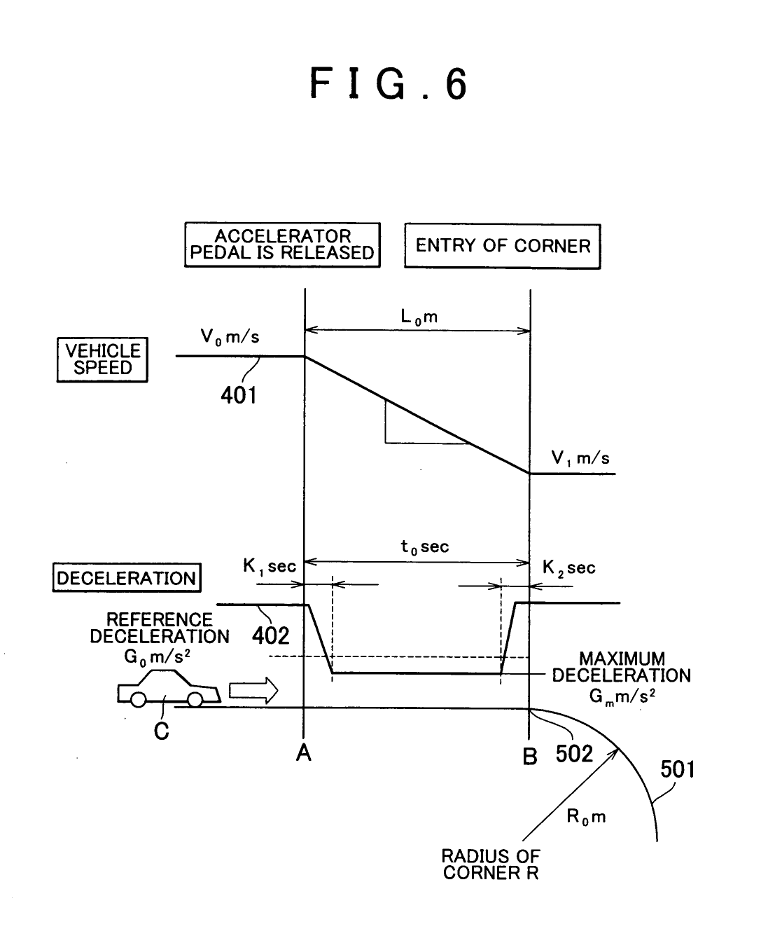

Operations according to this embodiment will be described with reference to FIG. 1, FIG. 2, and FIG. 6.

FIG. 6 is a diagram explaining a target deceleration in deceleration control according to this embodiment. FIG. 6 is a top view showing a road configuration including a vehicle speed 401, a deceleration 402, and a corner 501. In FIG. 6, a horizontal axis indicates a distance. The corner 501 is ahead of a vehicle C. An entry 502 of the corner 501 is at a spot B. It is assumed that the accelerator pedal is released (an accelerator pedal operation amount becomes 0, and an idle contact is turned on) at a spot A. At this spot A, brake is off. The spot A is before the entry 502 of the corner 501, and there is a distance L₀ between the spot A and the entry 502 of the corner 501.

When the vehicle C turns at the corner 501 at predetermined lateral acceleration, the vehicle speed 401 needs to be a vehicle speed V₁ at the spot B where there is the entry 502 of the corner 501. Accordingly, the vehicle speed 401 of the vehicle C needs to be decreased from a vehicle speed V₀ at the spot A where the accelerator pedal is released to the vehicle speed V₁ at the spot B where there is the entry 502 of the corner 501. In this embodiment, deceleration G402 for decreasing the vehicle speed from the vehicle speed V₀ to the vehicle speed V₁ is obtained.

[Step S1]

In step S1 in FIG. 1, the control circuit 130 determines whether there is a corner ahead of a vehicle. The control circuit 130 makes a determination in step S1 based on a signal input thereto from the navigation system device 95. If it is determined that there is a corner ahead of the vehicle in step S1, step S2 is performed. If not, this control is terminated. In the example shown in FIG. 6, since there is the corner 501 ahead of the vehicle C, step S2 is performed.

[Step S2]

In step S2, the control circuit 130 calculates a radius R₀ of the corner 501. The control circuit 130 calculates the radius R₀ of the corner 501 based on map information of the navigation system device 95. After step S2 is performed, step S3 is performed.

[Step S3]

In step S3, the control circuit 130 determines whether the idle contact is on. In this example, it is determined that a driver intends to perform deceleration when the idle contact is on (i.e., the accelerator pedal operation amount is 0). In step S3, it is determined whether the accelerator pedal has been released (i.e., the accelerator pedal operation amount is zero) based on the signal from the throttle opening degree sensor 114. If it is determined that the accelerator pedal has been released in step S3, step S4 is performed. Meanwhile, if it is determined that the accelerator pedal has not been released in step S3, step S3 is performed again. As described above, in the example shown in FIG. 6, since the accelerator pedal operation amount becomes zero at the spot A, step S4 is performed.

[Step S4]

In step S4, the control circuit 130 calculates the distance L₀ to the corner 501 and the present vehicle speed V₀. The control circuit 130 obtains the distance L₀ to the corner 501 from the spot A where the accelerator pedal is released, and the vehicle speed V₀ based on the signal input thereto from the navigation system device 95. After step S4 is performed, step S5 is performed.

[Step S5]

In step S5, the control circuit 130 estimates the driver's intention and the driver's driving skill level. In step S5, the control circuit 130 determines whether the driver intends to perform sport running (power running), normal running, or slow running. The control circuit 130 determines the driver's intention based on the driver's intention (the driver's intention estimation value) estimated by the driver's intention estimating portion 115. Also, in step S5, the driving skill level estimating portion 119 estimates the driving skill level.

In step S5, the driver's intention may be determined by inputting, to the neural network, the throttle opening degree, the vehicle speed, the engine rotational speed, the rotational speed of the input shaft of the transmission, a shift lever position, and a brake operation signal, as disclosed, for example, in Japanese Patent Application Publication No. JP-A-9-242863. Also, in step S5, the driving skill level may be estimated based on a shock that is caused when brake is applied and the vehicle is stopped, as disclosed, for example, in Japanese Patent Application Publication No. JP-A-5-196632. After step S5 is performed, step S6 is performed.

[Step S6]

In step S6, the control circuit 130 obtains the maximum lateral acceleration during cornering. In step S6, the maximum lateral acceleration while the vehicle runs at the corner 501 is obtained based on the driver's intention and the driving skill level that are estimated in the aforementioned step S5. The ROM 133 stores in advance a maximum lateral acceleration map shown in FIG. 9. As shown in FIG. 9, the maximum lateral acceleration map shows values of the maximum lateral acceleration corresponding to the driver's intentions and the driving skill levels in a table form. For example, in a case where the driver intends to perform sport running, and the driver's driving skill level is high, the maximum lateral acceleration is 0.7 G In a case where the driver intends to perform sport running, the maximum lateral acceleration is great, as compared to a case where the driver intends to perform slow running. In a case where the driving skill level is high, the maximum lateral acceleration is great, as compared to a case where the driving skill level is low.

In step S7 described later, the cornering vehicle speed V₁ is obtained based on the maximum lateral acceleration obtained in step S6 and the radius R₀ of the corner 501 obtained in the aforementioned step S2. If the maximum lateral acceleration obtained from the maximum lateral acceleration map in FIG. 9 were used without being corrected in a case where a radius of the corner is large, the cornering vehicle speed would become high (the deceleration control according to this embodiment would not be performed), that is, the cornering vehicle speed would become an unrealistic value. Accordingly, a coefficient decided by the radius of the corner is obtained as shown in FIG. 10. The maximum lateral acceleration obtained from the maximum lateral acceleration map in FIG. 9 is multiplied by the coefficient, whereby the maximum lateral acceleration can be corrected. As shown in FIG. 10, in the case where the radius of the corner is large, the coefficient is set to a small value, and the maximum lateral acceleration is corrected to a small value. Therefore, in step S7 described later, a realistic value of the cornering vehicle speed is obtained.

Description has been made of the example in which the two maps are used. The two maps are the map for obtaining the maximum lateral acceleration based on the driving skill level and the driver's intention, and the map for obtaining the coefficient based on the radius of the corner. Instead, it is possible to employ a map for obtaining the appropriate maximum lateral acceleration (that is equivalent to the aforementioned corrected maximum lateral acceleration) based on the driving skill level, the driver's intention, and the radius of the corner. After step S6 is performed, step S7 is performed.

[Step S7]

In step S7, the control circuit 130 obtains the cornering vehicle speed V₁ based on the maximum lateral acceleration and the radius of the corner. The control circuit 130 obtains the vehicle speed at the entry 502 of the corner 501 (i.e., the cornering vehicle speed V₁) based on the maximum lateral acceleration obtained in the aforementioned step S6, and the radius R₀ of the corner 501 obtained in the aforementioned step S2. The control circuit 130 obtains the cornering vehicle speed V₁ using an equation 1 described below. After step S7 is performed, step S8 is performed.
V₁\sqrt{lateral acceleration×R₀} Equation 1

Hereinafter, the aforementioned equation 1 will be derived. As shown in FIG. 8, when a body having mass m is moving on a circle having the radius R₀, centrifugal force is represented by an equation, centrifugal force=m×R₀×ω², and force is represented by an equation, force=m×lateral acceleration. In these equations, R₀ is the radius [m], ω is angular velocity [rad/sec], and m is the mass of the body [kg].

Based on the two equations, an equation, m×lateral acceleration=m×R₀×ω² is obtained. This equation can be modified to an equation, lateral acceleration=R₀×ω²[m/sec²]. Also, the vehicle speed V₁ of the body is represented by an equation, V₁=2πR₀×ω/(2π)=R₀×ω[m/sec].

By substituting an equation, ω=V₁/R₀ into the equation relating to the lateral acceleration, an equation, lateral acceleration=R₀×V₁²/R₀² is obtained. Since V₁²=lateral acceleration×R₀, V₁ is represented by the aforementioned equation 1.

[Step S8]

In step S8, the control circuit 130 calculates the target deceleration. The target deceleration is set so as to decrease the vehicle speed from the vehicle speed V₀ at the spot A where the accelerator pedal is released to the vehicle speed V₁ at the spot B where there is the entry 502 of the corner 501 in FIG. 6. The target deceleration corresponds to the deceleration G402 in the distance from the spot A to the spot B. In step S8, the control circuit 130 obtains the target deceleration based on the distance L₀ to the corner 501 and the vehicle speed V₀ at the spot A that are obtained in the aforementioned step S4, and the vehicle speed V₁ at the spot B that is obtained in step 7.

In step S8, the target deceleration is set. The target deceleration is linearly increased from the spot A. Subsequently, the target deceleration becomes a constant value, and then is linearly decreased. In order to set the target deceleration in such a manner, a gradient of the linear increase in the target deceleration, a gradient of the linear decrease in the target deceleration, and the maximum target gravitational deceleration Gₘ (hereinafter, referred to as “maximum target deceleration Gₘ”) are obtained in step S8. As shown in FIG. 6, the gradient of the increase in the target deceleration and the gradient of the decrease in the target deceleration are decided by constants K₁ and K₂, respectively. The target deceleration is increased from 0 to the maximum deceleration Gₘ in K₁ seconds, and is decreased from the maximum deceleration Gₘ to 0 in K₂ seconds.

It is possible to obtain a reference gravitational deceleration G₀ (hereinafter, referred to as “reference deceleration G₀”) required for decreasing the vehicle speed from the vehicle speed V₀ to the vehicle speed V₁ in the distance L₀ from the spot A to the spot B, and a time t₀ required for moving from the spot A to the spot B, using an equation 2 described below.

$$\{ \begin{matrix}{G}_{0} = ( {V}_{0}^{2} - {V}_{1}^{2} ) / 2 {L}_{0} \\ {t}_{0} = ( {V}_{0} - {V}_{1} ) / {G}_{0} \end{matrix} \qquad [ Equation 2 ]$$

Hereinafter, the aforementioned equation 2 will be derived. Equation 3 described below is the physical equation when entering the corner.

$$\{ \begin{matrix}{V}_{1} = {V}_{0} - {\int }_{0}^{t0} {G}_{0} ⅆ t = {V}_{0} - {G}_{0} \times {t}_{0} \\ {L}_{0} = {\int }_{0}^{t0} ( {V}_{0} - {G}_{0} \times t ) ⅆ t = {V}_{0} {t}_{0} - \frac{{G}_{0} {t}_{0}^{2}}{2}\end{matrix} \qquad [ Equation 3 ]$$

In the equation 3, V₀ is the vehicle speed when the accelerator pedal is released [m/sec]. This value has already been obtained.

V₁ is the vehicle speed at the entry of the corner [m/sec]. This value has already been obtained.

L₀ is the distance to the entry of the corner [m]. This value has already been obtained.

G₀ is the reference deceleration [m/sec²]. This value has not been obtained. (The deceleration at which the vehicle is decelerated is increased in K₁ seconds.)

t₀ is the time required for moving from the spot A where the accelerator pedal is released to the spot B where there is the entry of the corner [sec]. This value has not been obtained.

Based on the aforementioned equation 3, an equation 4 described below can be obtained.
t₀=(V₀−V₁)/G₀ [Equation 4]

By substituting the equation 4 into the equation 3, an equation 5 described below can be obtained.

$$\{ \begin{matrix}{L}_{0} = {V}_{0} ( {V}_{0} - {V}_{1} ) / {G}_{0} - \frac{{G}_{0} {\{ ( {V}_{0} - {V}_{1} ) / {G}_{0} \}}^{2}}{2} \\ {L}_{0} = \frac{{V}_{0}^{2} - {V}_{0} {V}_{1}}{{G}_{0}} - \frac{{( {V}_{0} - {V}_{1} )}^{2}}{2 {G}_{0}} \\ 2 {L}_{0} = \frac{2 {V}_{0}^{2} - 2 {V}_{0} {V}_{1}}{{G}_{0}} + \frac{- {V}_{0}^{2} + 2 {V}_{0} {V}_{1} - {V}_{1}^{2}}{{G}_{0}} \\ = \frac{{V}_{0}^{2} - {V}_{1}^{2}}{{G}_{0}} \end{matrix} \qquad [ Equation 5 ]$$

Thus, G₀ and t₀ are represented by an equation 6 described below.

$$\{ \begin{matrix}{G}_{0} = ( {V}_{0}^{2} - {V}_{1}^{2} ) / 2 {L}_{0} \\ {t}_{0} = ( {V}_{0} - {V}_{1} ) / {G}_{0} \end{matrix} \qquad [ Equation 6 ]$$

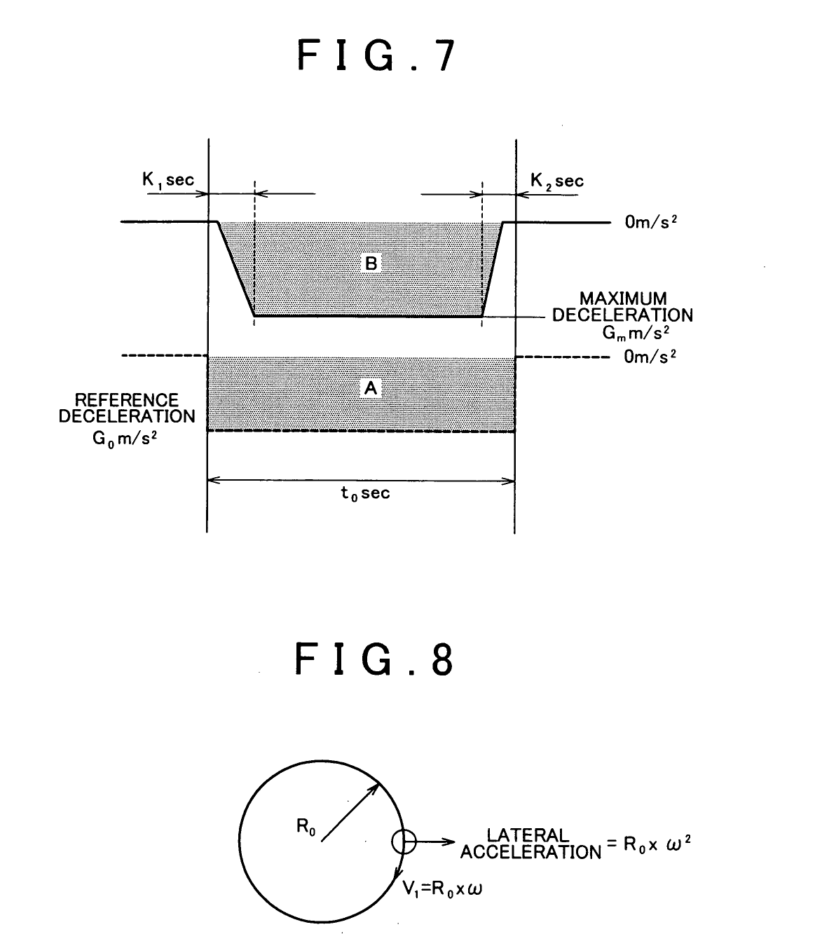

In a case where K₁ and K₂ are set so that the deceleration is increased and decreased smoothly, and the maximum deceleration is set to the deceleration Gₘ, the vehicle speed is decreased from the vehicle speed V₀ to the vehicle speed V₁ in t₀ seconds if an area A (=G₀×t₀) is equal to an area B (=(t₀+t₀−K₁−K₂)×Gₘ/2), as shown in FIG. 7.

The upper equation V₁=V₀−G₀×t₀ in the aforementioned equation 3 is obtained using an equation 7 described below.

$$\begin{matrix}{V}_{1} = {V}_{0} - {\int }_{0}^{t0} {G}_{0} ⅆ t = {V}_{0} - \int g ( t ) ⅆ t , & [ Equation 7 ] \\ g ( t ) ; deceleration time waveform & \end{matrix}$$

That is, a time-integral value of a deceleration time waveform is equivalent to an amount of decrease in the vehicle speed. Therefore, if the area A is equal to the area B, the amount of decrease in the vehicle speed corresponding to the area A is equal to the amount of decrease in the vehicle speed corresponding to the area B. Accordingly, the maximum target deceleration Gₘ is represented by an equation 8 described below.
Gₘ=(G₀×t₀)/(t₀−K₁/2−K₂/2) [Equation 8]

However, the area B may not become a trapezoid as shown in FIG. 7, and may become a triangle, depending on a condition (i.e., in a case where an equation (t₀−K₁/2−K₂/2)≦0) is satisfied). In this case as well, the waveform is set so that the area B becomes equal to the area A. For example, G₀ and t₀ may be used as they are. Also, an equation 9 described below may be used.

$$\{ \begin{matrix}{G}_{m} = 2 {G}_{0} \\ {K}_{1} = {t}_{0} \times {K}_{1} / ( {K}_{1} + {K}_{2} ) \\ {K}_{2} = {t}_{0} \times {K}_{2} / ( {K}_{1} + {K}_{2} )\end{matrix} \qquad [ Equation 9 ]$$

Thus, in step S8, the target deceleration that is set so as to decrease the vehicle speed from the vehicle speed V₀ at the spot A to the vehicle speed V₁ at the spot B is obtained such that the target deceleration corresponds to the deceleration G402. After step S8 is performed, step S9 is performed.

[Step S9]

In step S9, the control circuit 130 performs the deceleration control so that the actual deceleration becomes equal to the target deceleration. The control circuit 130 performs the deceleration control based on the target deceleration obtained in the aforementioned step S8. In step S9, the brake control circuit 230 performs feedback control of the brake so that the actual deceleration applied to the vehicle becomes equal to the target deceleration. The feedback control of the brake is started at the spot A where the accelerator pedal is released.

That is, as the braking force signal SG1, the signal indicative of the target deceleration starts to be output from the control circuit 130 to the brake control circuit 230 through the braking force signal line L1 at the spot A. The brake control circuit 230 generates the brake control signal SG2 based on the braking force signal SG1 input thereto from the control circuit 130. Then, the brake control circuit 230 outputs the brake control signal SG2 to the hydraulic pressure control circuit 220.

The hydraulic pressure control circuit 220 controls the hydraulic pressure to be supplied to each of the braking devices 208, 209, 210, and 211 based on the brake control signal SG2, thereby generating the braking force according to an instruction included in the brake control signal SG2.

In the feedback control of the brake device 200 in step S9, a target value is the target deceleration, a control amount is the actual deceleration of the vehicle, and a device to be controlled is the brake (braking devices 208, 209, 210, and 211), and an operation amount is a brake control amount (not shown). The actual deceleration of the vehicle is detected by the acceleration sensor 90. That is, in the brake device 200, the braking force (brake control amount) is controlled so that the actual deceleration of the vehicle becomes equal to the target deceleration. After step S9 is performed, this control is terminated.

According to the embodiment that has been described so far, the following effects can be obtained.

In a case where a corner is detected ahead of the vehicle, and the driver's request for deceleration is detected (i.e., the idle contact is turned on), the maximum lateral acceleration during cornering is calculated based on the driver's intention and the driving skill level. Based on the calculated maximum lateral acceleration, the cornering vehicle speed is obtained, and the target deceleration is decided. Since the deceleration control is performed so that the actual deceleration becomes equal to the target deceleration, it is possible to obtain the deceleration expected by the driver. Accordingly, driveability can be improved, a load on the driver can be reduced, and a driver's comfort level can be increased.

### Second Embodiment

Next, a second embodiment will be described. The second embodiment relates to a deceleration control apparatus which performs cooperative control of the brake (brake device) and the automatic transmission. In the second embodiment, description of the same portions as in the first embodiment will be omitted, and only characteristic portions will be described.

In the second embodiment, the same operations as those in steps S1 to S8 in FIG. 1 in the first embodiment are performed. An operation in step S9 in the second embodiment is different from the operation in step S9 in the first embodiment. That is, in the first embodiment, the deceleration control is performed so that the deceleration applied to the vehicle becomes equal to the target deceleration obtained in the aforementioned step S8, using only the brake. Meanwhile, in the second embodiment, deceleration control is performed so that the deceleration applied to the vehicle becomes equal to the target deceleration obtained in the aforementioned step S8, using the cooperative control of the brake and the automatic transmission.

[Step S9]

In step S9 in the second embodiment, the control circuit 130 performs both of shift control and brake control. First, the shift control will be described, and then, the brake control will be described.

A. Shift Control

In the shift control in step S9, the control circuit 130 obtains the target deceleration to be achieved by the automatic transmission 10 (hereinafter, referred to as “shift speed target deceleration”), and decides a shift speed to be selected when shifting (downshifting) of the automatic transmission 10 is performed, based on the shift speed target deceleration. Hereinafter, the shift control in step S9 will be described in the following (1) and (2).

(1) First, the shift speed target deceleration is obtained.

The shift speed target deceleration corresponds to the engine braking force (deceleration) to be obtained by the shift control of the automatic transmission 10. The shift speed target deceleration is set to be equal to or less than the maximum target deceleration. The shift speed target deceleration can be obtained according to the following three methods.

A first method of obtaining the shift speed target deceleration will be described. The shift speed target deceleration is set to a value obtained by multiplying the maximum target deceleration Gₘ obtained in step S8 by a coefficient which is larger than 0 and is equal to or smaller than 1. For example, when the maximum target deceleration Gₘ is −0.20 G, for example, the shift speed target deceleration is set to −0.10 G, which is obtained by multiplying the maximum target deceleration Gₘ by a coefficient of 0.5.

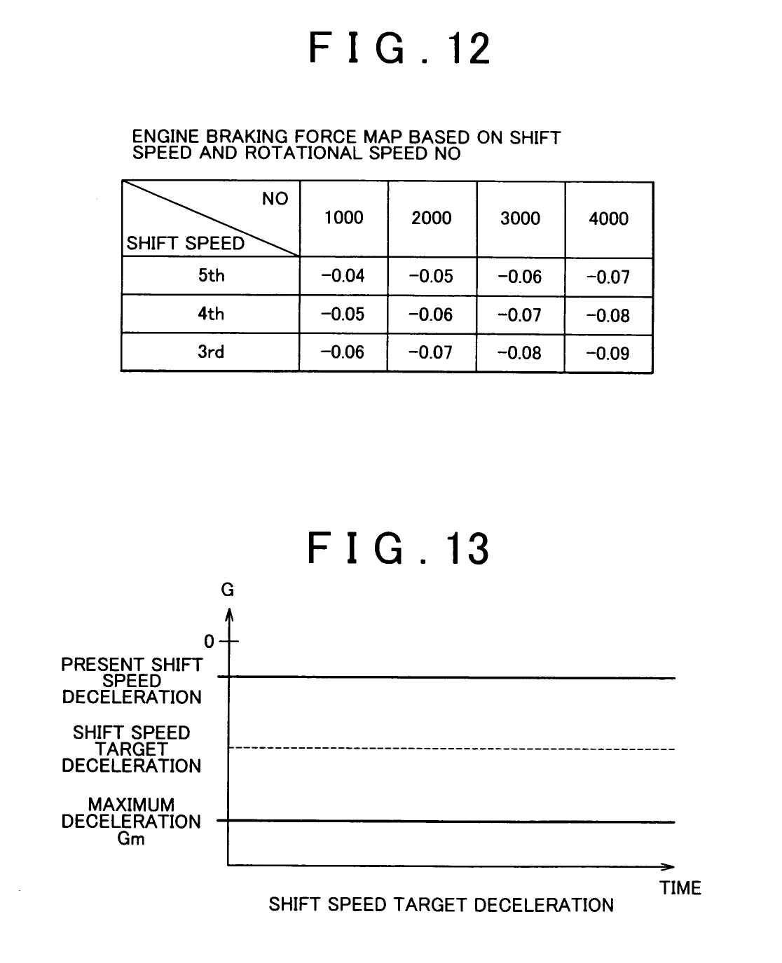

Next, a second method of obtaining the shift speed target deceleration will be described. First, the engine braking force (deceleration) at a present shift speed of the automatic transmission 10 when the accelerator pedal is released (hereinafter, referred to as “present shift speed deceleration”) is obtained. A present shift speed deceleration map (FIG. 12) is stored in the ROM 133 in advance. With reference to the present shift speed deceleration map in FIG. 12, the present shift speed deceleration is obtained. As shown in FIG. 12, the present shift speed deceleration is obtained based on a shift speed and a rotational speed NO of the output shaft 120c of the automatic transmission 10. For example, in a case where the present shift speed is fifth speed, and the output rotational speed is 1000 [rpm], the present shift speed deceleration is −0.04 G

The present shift speed deceleration may be obtained by correcting the value obtained using the present shift speed deceleration map, according to whether an air conditioner of the vehicle is operated, whether fuel cut is performed, and the like. Also, plural present shift speed deceleration maps may be stored in the ROM 133, and the present shift sped deceleration map which is used is changed according to whether the air conditioner of the vehicle is operated, whether fuel cut is performed, and the like.

Next, the shift speed target deceleration is set to a value between the present shift speed deceleration and the maximum target deceleration Gₘ. That is, the shift speed target deceleration is set to a value which is larger than the present shift speed deceleration, and is equal to or less than the maximum target deceleration Gₘ. FIG. 13 shows one example of a relationship between the shift speed target deceleration, and the present shift speed deceleration and the maximum target deceleration Gₘ.

The shift speed target deceleration can be obtained using the following equation.
shift speed target deceleration=(maximum target deceleration Gₘ−present shift speed deceleration)×coefficient+present shift speed deceleration.

In this equation, the coefficient is larger than 0, and is equal to or smaller than 1.

In a case where the maximum target deceleration Gₘ is −0.20 G, the present shift speed deceleration is −0.04 G, and the coefficient is 0.5, the shift speed target deceleration becomes −0.12 G in the aforementioned example.

After the shift speed target deceleration is obtained in step S9, the shift speed target deceleration is not reset until the deceleration control is finished. As shown in FIG. 13, the shift speed target deceleration (a value shown by a dashed line) is constant even time elapses.

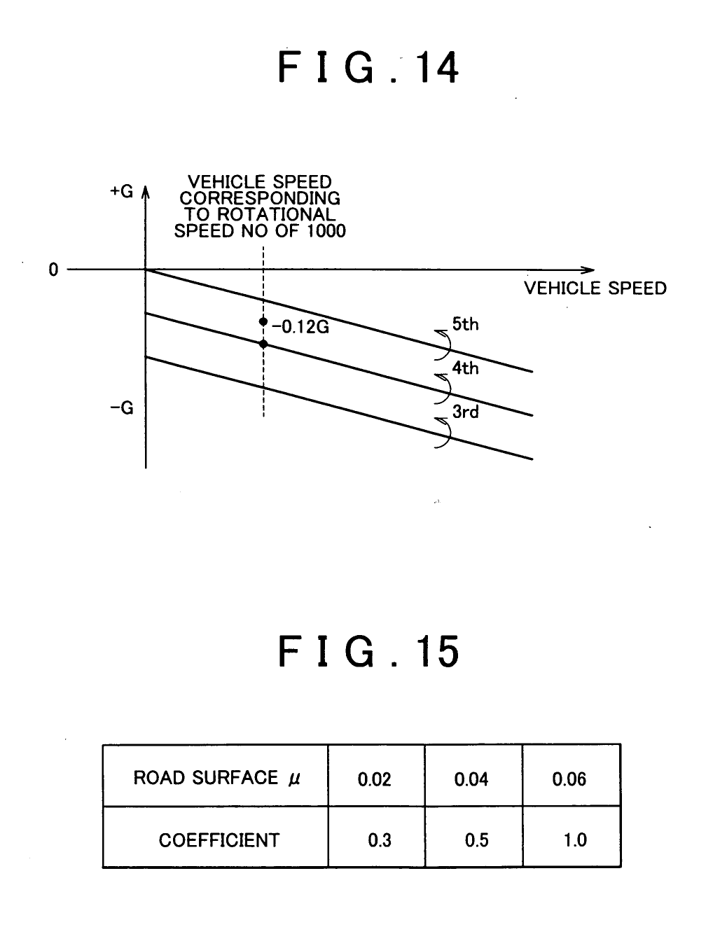

(2) Next, the shift speed to be selected is decided when the shift control of the automatic transmission 10 is performed based on the shift speed target deceleration obtained in (1). The ROM 133 stores vehicle characteristic data showing the deceleration when the accelerator pedal is released at each vehicle speed in a case of each shift speed, as shown in FIG. 14.

As in the aforementioned example, in a case where the output rotational speed is 1000 [rpm], and the shift speed target deceleration is −0.12 G, a shift speed which corresponds to a vehicle speed when the output rotational speed is 1000 [rpm], and at which the deceleration becomes closest to −0.12 G that is the shift speed target deceleration is fourth speed in FIG. 14. Thus, in the aforementioned example, in the shift control in step S9, it is decided that the shift speed to be selected is fourth speed. The shift control in step S9 is performed (i.e., a command for downshifting to the aforementioned shift speed to be selected is output) at the spot A where the accelerator pedal is released.

In this case, it is decided that the shift speed to be selected is the shift speed at which the deceleration is closest to the shift speed target deceleration. However, the shift speed to be selected may be a shift speed at which the deceleration becomes equal to or less (or equal to or greater) than the shift speed target deceleration, and which is closest to the shift speed target deceleration.

B. Brake Control

In the brake control in step S9, the brake control circuit 230 performs the feedback control of the brake so that the actual deceleration applied to the vehicle becomes equal to the target deceleration. The feedback control of the brake is performed at the spot A where the accelerator pedal is released.

That is, as the braking force signal SG1, a signal indicative of the target deceleration starts to be output from the control circuit 130 to the brake control circuit 230 through the braking force signal line L1 at the spot A. The brake control circuit 230 generates the brake control signal SG2 based on the braking force signal SG1 input thereto from the control circuit 130. Then, the brake control circuit 230 outputs the brake control signal SG2 to the hydraulic control circuit 220.

The hydraulic control circuit 220 controls hydraulic pressure to be supplied to each of the braking devices 208, 209, 210, and 211 based on the brake control signal SG2, thereby generating the braking force according to the instruction included in the brake control signal SG2.

In the feedback control of the brake device 200 in the brake control in step S9, the target value is the target deceleration, the control amount is the actual deceleration of the vehicle, the device to be controlled is the brake (braking devices 208, 209, 210, and 211), the operation amount is the brake control amount (not shown), and main disturbance is deceleration caused by shifting of the automatic transmission 10 according to the shift control in step S9. The actual deceleration of the vehicle is detected by the acceleration sensor 90.

That is, in the brake device 200, the braking force (brake control amount) is controlled so that the actual vehicle speed of the vehicle becomes equal to the target deceleration. That is, the brake control amount is set so as to cause a deceleration equivalent to shortage of the deceleration caused by shifting of the automatic transmission 10 according to the shift control in step S9.

### Third Embodiment

Next, a third embodiment will be described.

Description of the same portions as in the aforementioned embodiments will be omitted, and only the characteristic portion will be described.

In the third embodiment, the target deceleration calculated in the aforementioned step S8 in FIG. 1 is corrected by a road inclination in step S9, whereby deceleration at which the driver feels more comfortable can be obtained (i.e., deceleration expected by the driver can be obtained). That is, in the third embodiment, an operation in step S9 is different from the operation in step S9 in the first embodiment or the second embodiment (operations in steps S1 to S8 are the same as in the first embodiment or the second embodiment).

[Step S9]

In step S9 in the third embodiment, the road inclination measuring estimating portion 118 measures or estimates the road inclination. Next, an inclination correction amount (deceleration) corresponding to the road inclination measured or estimated by the road inclination measuring estimating portion 118 is obtained. For example, in a case where the inclination is 1%, the inclination correction amount (deceleration) is approximately 0.01 G (in the case of ascending inclination, the inclination correction amount is +0.01 G and in the case of descending inclination, the inclination correction amount is −0.01 G).

The corrected target deceleration is obtained, using an equation described below.
corrected target deceleration=target deceleration obtained in step S8+inclination correction amount

When the aforementioned correction is performed, the target deceleration is corrected so as to be a large value in the case of the descending inclination, for example, in the case of a descending slope. Meanwhile, the deceleration is corrected so as to be a small value in the case of the ascending inclination. In step S9, the control circuit 130 performs the deceleration control based on the corrected target deceleration.

In the third embodiment, the target deceleration is corrected according to the inclination of the road where the vehicle runs, deceleration at which the driver feels more comfortable can be obtained (i.e., deceleration expected by the driver can be obtained).

### Forth Embodiment

Next, a fourth embodiment will be described.

In the fourth embodiment, description of the same portions as in the aforementioned embodiments will be omitted, and only the characteristic portion will be described.

In the fourth embodiment, in the aforementioned step S6 in FIG. 1, the maximum lateral acceleration that is thus calculated is corrected using road surface μ. That is, in the fourth embodiment, the operation in step S6 is different from the operation in step S6 in the first embodiment or the second embodiment (operations in steps S1 to S5, and the operations in steps S7 to S9 are the same as in the first embodiment or the second embodiment).

[Step S6]

In step S6 in the fourth embodiment, the maximum lateral acceleration obtained by the method in the first embodiment (in FIG. 9, and FIG. 10) is corrected based on the road surface μ that is detected or estimated by the road surface μ detecting estimating portion 112. A coefficient corresponding to the road surface μ that is detected or estimated by the road surface μ detecting estimating portion 112 is calculated based on a map as shown in FIG. 15. The maximum lateral acceleration obtained by the method in the first embodiment (FIG. 9 and FIG. 10) is multiplied by the coefficient, whereby the maximum lateral acceleration is corrected.

As shown in FIG. 15, as the road surface μ is smaller (a road surface is more slippery), the maximum lateral acceleration is corrected so as to be a smaller value. In the fourth embodiment, deceleration at which the driver feels more comfortable can be obtained (i.e., deceleration expected by the driver can be obtained).

In each of the aforementioned embodiments, the driver's intention is estimated by the driver's intention estimating portion 115. However, the driver himself may input the driver's intention to the control circuit 130 by operating a switch or the like. In each of the embodiments, the driving skill level is estimated by the driving skill level estimating portion 119. However, the driver himself may input the driving skill level to the control circuit 130 by operating a switch or the like.

Also, the deceleration control (brake control) in each of the aforementioned embodiments can be performed using other brakes which generate braking force in the vehicle, such as a regenerative brake using a motor/generator device provided in a power train system, and an exhaust brake, instead of the aforementioned brake. Further, the amount of decrease in the vehicle speed has been described using the deceleration (G). However, the control may be performed using deceleration torque.

1. A deceleration control apparatus for a vehicle, comprising:
a calculation device which calculates a target deceleration for running on a curved road ahead of a vehicle, based on driver's intention relating to running of the vehicle which is input or estimated, and a driver's driving skill level which is input or estimated; and
a control device which performs deceleration control for the vehicle based on the calculated target deceleration.

2. The deceleration control apparatus according to claim 1, wherein in a case where the driver's intention is to cause the vehicle to respond to driving operation relatively quickly, the calculation device sets the target deceleration to a relatively small value; and in a case where the driving skill level is relatively high, the calculation device sets the target deceleration to a relatively small value.

3. The deceleration control apparatus according to claim 1, wherein the calculation device sets the target deceleration based on a state of a road where the vehicle runs.

4. The deceleration control apparatus according to claim 1, further comprising a driving skill estimating portion that estimates the driving skill level based on at least one of data that is input by the driver, a result of statistical analysis of an operation amount relating to driving, and a difference between ideal operation and actual operation.

5. The deceleration control apparatus according to claim 1, further comprising a driver's intention estimating portion that estimates the driver's intention relating to running of the vehicle, based on at least one of a driving state of the driver and a running state of the vehicle.

6. The deceleration control apparatus according to claim 1, wherein the driver's intention estimating portion includes a neural network which receives at least one of plural variables related to driving operation, and starts an estimating operation every time the at least one variable is calculated; and the driver's intention estimating portion estimates the driver's intention in the vehicle based on output from the neural network.

7. The deceleration control apparatus according to claim 1, wherein the control device performs the deceleration control so that a deceleration applied to the vehicle becomes equal to the target deceleration using cooperative control of a brake and an automatic transmission.

8. The deceleration control apparatus according to claim 1, wherein the calculation device corrects the target deceleration according to an inclination of a road where the vehicle runs.

9. The deceleration control apparatus according to claim 1, wherein the calculation device corrects the target deceleration such that a maximum lateral acceleration becomes smaller as a friction coefficient of a road becomes smaller.

10. A deceleration control method for a vehicle, comprising:
calculating a target deceleration for running on a curved road ahead of a vehicle, based on driver's intention relating to running of the vehicle which is input or estimated, and a driver's driving skill level which is input or estimated; and
performing deceleration control for the vehicle based on the calculated target deceleration.
